(19) United States
(12) Patent Application Publication
(10) Pub. No.: US 2007/0124192 A1
(43) Pub. Date: May 31, 2007

(54) Dynamic conversion rate optimization

(75) Inventor: Yosef Moatti, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/289,234

(22) Filed: Nov. 29, 2005

(51) Int. Cl. G07G 1/00

(52) U.S. Cl. 705/10

(57) ABSTRACT

A method for dynamically optimizing the conversion rate of a solicitation over time, the method including selecting a presentation factor in a solicitation, creating at least two versions of the solicitation by varying the factor, determining a conversion rate for each of the versions, presenting one of the versions having the highest conversion rate at a first presentation rate, presenting the other of the versions having the lowest conversion rate at a second presentation rate that is lower than the first presentation rate, and varying any of the presentation rates responsive to a change in the conversion rate of any of the versions.

### FIELD OF THE INVENTION

The present invention relates to marketing management systems in general, and more particularly to dynamic optimization of conversion rates.

### BACKGROUND OF THE INVENTION

Advertisers, web site owners, and others who present advertisements, web pages, and other forms of information to recipients are typically concerned with having the recipient take a desired action, such as buying a product, clicking on a hypertext link, or providing information. The rate at which recipients of such active or passive solicitations take a desired action is referred to as their “conversion rate.” One technique that marketers use to test and increase conversion rates, alternatively known as A/B Testing, Split Testing, or Split-Run Testing, involves presenting alternate forms of a solicitation to a test group, such as where the solicitation's text, color scheme, or other elements are varied. The form with the highest conversion rate is then selected as the solicitation that all other recipients will receive, on the assumption that the solicitation's overall conversion rate will be similar to the test group conversion rate.

Unfortunately, selecting a solicitation based on A/B Testing does not take advantage of temporary changes in recipient preferences that may occur. By way of example, consider a web page for which a single factor F is to be varied with possible values V1 and V2. Two versions of the web page, one with F being set to V1, the other with F being set to V2, are A/B tested during a given span of time, resulting in a test group conversion rate of 15% for F=V1 and 10% for F=V2, resulting in the selection of F=V1. Over a one-week period, the following daily conversion rates were observed:

| Day | Conversion Rate, F = V1 |
|---|---|
| 1 | 16 |
| 2 | 22 |
| 3 | 14 |
| 4 | 7 |
| 5 | 18 |
| 6 | 13 |
| 7 | 15 |

Although the overall conversion rate is 15%, the same as the test group conversion rate, the conversion rate on day four was half that of the test group conversion rate.

There are also situations where A/B Testing results will vary depending on when the test begins and how long the test lasts. For example, A/B Testing may show that over the course of one month a web page layout option A provides the highest overall conversion rate. However, while testing shows that option A is optimal most of the time, during a few hours each week, the time of which varies from week to week, layout option B provides a higher conversion rate than does option A.

A testing and selection methodology that dynamically optimizes conversion rates of solicitations over time would therefore be advantageous.

### SUMMARY OF THE INVENTION

The present invention discloses a system and method for dynamically optimizing conversion rates of solicitations over time.

In one aspect of the present invention a method is provided for dynamically optimizing the conversion rate of a solicitation over time, the method including selecting a presentation factor in a solicitation, creating at least two versions of the solicitation by varying the factor, determining a conversion rate for each of the versions, presenting one of the versions having the highest conversion rate at a first presentation rate, presenting the other of the versions having the lowest conversion rate at a second presentation rate that is lower than the first presentation rate, and varying any of the presentation rates responsive to a change in the conversion rate of any of the versions.

In another aspect of the present invention the varying step includes varying any of the presentation rates by a predetermined increment.

In another aspect of the present invention the varying step includes varying any of the presentation rates in accordance with a predefined function of the change in any of the conversion rates.

In another aspect of the present invention the determining step includes determining using A/B testing on a test group.

In another aspect of the present invention the method further includes associating with each of the factors, where each factor has an associated set of candidate values, a probability currentProb between 0 and 1 that a given one of the values will be chosen for a next presentation, associating with each of the factors a minimum value currentDelta for the currentProb and for (1−currentProb), for each of the factors testing the conversion rates associated with the candidate values of the factor during a bounded period of time, and during the test period setting currentProb=1 for any previously tested factor, setting currentProb=5 for all non-tested factors, modifying currentProb for the currently tested factor in accordance with a predefined function to reflect the confidence with which any of the candidate values should be chosen. sampling the conversion rates for at least two of the values of a tested factor during the test period, maintaining the current presentation rates where no statistically significant better conversion rate was found, and assigning a higher presentation rate (1−currentDelta) to the value having a statistically significant better conversion rate, and a complementary presentation rate (currentDelta) to the other value.

In another aspect of the present invention the method further includes determining for each new solicitation recipient what values should be chosen for the presentation factors as a function of their current currentProb values, and after each presentation, recording information relating to the latest recipient, including any of recipient profile information, the presentation choices that were used for the recipient, and whether the presentation led to a conversion success or a failure.

In another aspect of the present invention the method further includes updating a results repository with the information, measuring and analyzing the information to determine if any of the values for any of the factors should be adjusted, and, adjusting any of the currentProb values in the range of [currentDelta, 1−currentDelta] in order to optimize any of the conversion rates.

In another aspect of the present invention a system is provided for dynamically optimizing the conversion rate of a solicitation over time, the system including means for selecting a presentation factor in a solicitation, means for creating at least two versions of the solicitation by varying the factor, means for determining a conversion rate for each of the versions, means for presenting one of the versions having the highest conversion rate at a first presentation rate, means for presenting the other of the versions having the lowest conversion rate at a second presentation rate that is lower than the first presentation rate, and means for varying any of the presentation rates responsive to a change in the conversion rate of any of the versions.

In another aspect of the present invention the means for varying is operative to vary any of the presentation rates by a predetermined increment.

In another aspect of the present invention the means for varying is operative to vary any of the presentation rates in accordance with a predefined function of the change in any of the conversion rates.

In another aspect of the present invention the means for determining is operative to determine using A/B testing on a test group.

In another aspect of the present invention the system further includes means for associating with each of the factors, where each factor has an associated set of candidate values, a probability currentProb between 0 and 1 that a given one of the values will be chosen for a next presentation, means for associating with each of the factors a minimum value currentDelta for the currentProb and for (1−currentProb), and means operative for each of the factors to test the conversion rates associated with the candidate values of the factor during a bounded period of time, and during the test period set currentProb=1 for any previously tested factor, set currentProb=5 for all non-tested factors, modify currentProb for the currently tested factor in accordance with a predefined function to reflect the confidence with which any of the candidate values should be chosen. sample the conversion rates for at least two of the values of a tested factor during the test period, maintain the current presentation rates where no statistically significant better conversion rate was found, and assign a higher presentation rate (1−currentDelta) to the value having a statistically significant better conversion rate, and a complementary presentation rate (currentDelta) to the other value.

In another aspect of the present invention the system further includes means for determining for each new solicitation recipient what values should be chosen for the presentation factors as a function of their current currentProb values, and means for recording after each presentation information relating to the latest recipient, including any of recipient profile information, the presentation choices that were used for the recipient, and whether the presentation led to a conversion success or a failure.

the system further includes means for updating a results repository with the information, means for measuring and analyzing the information to determine if any of the values for any of the factors should be adjusted, and, means for adjusting any of the currentProb values in the range of [currentDelta, 1−currentDelta] in order to optimize any of the conversion rates.

In another aspect of the present invention a computer-implemented program is provided embodied on a computer-readable medium, the computer program including a first code segment operative to select a presentation factor in a solicitation, a second code segment operative to create at least two versions of the solicitation by varying the factor, a third code segment operative to determine a conversion rate for each of the versions, a fourth code segment operative to present one of the versions having the highest conversion rate at a first presentation rate, a fifth code segment operative to present the other of the versions having the lowest conversion rate at a second presentation rate that is lower than the first presentation rate, and a sixth code segment operative to vary any of the presentation rates responsive to a change in the conversion rate of any of the versions.

It is appreciated throughout the specification and claim that the term “solicitation” refers to any type of presentation or showing to a person for which a conversion rate of a desired action taken by the person may be measured. Examples of solicitations may include, but are not limited to, print, radio, or direct-mail advertisements and network-based web pages.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a solicitation conversion rate optimization system, constructed and operative in accordance with a preferred embodiment of the present invention; and

FIG. 2 is a simplified flowchart illustration of an exemplary method of operation of the system of FIG. 1, operative in accordance with a preferred embodiment of the present invention.

### DETAILED DESCRIPTION OF THE INVENTION

Although the present invention is described by way of example using web pages, it is appreciated that the invention applies to any type of solicitation.

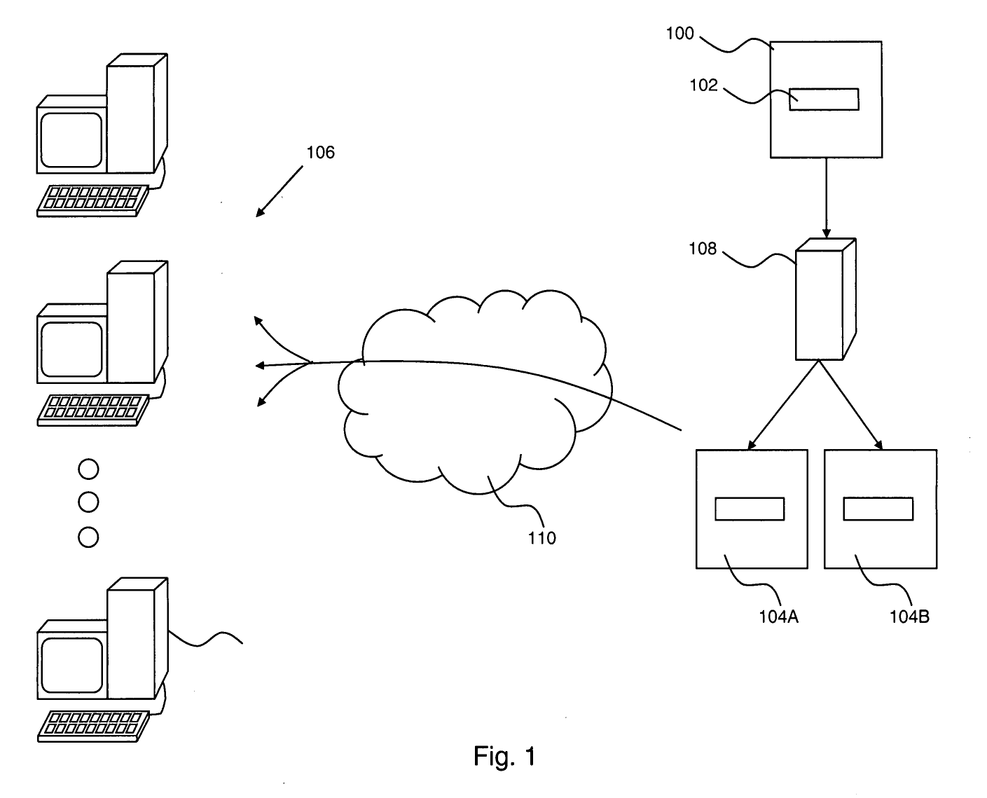

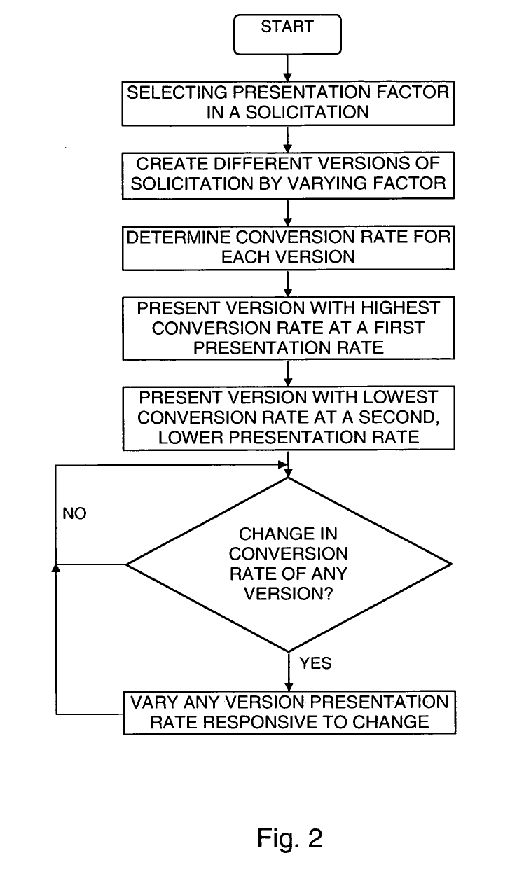

Reference is now made to FIG. 1, which is a simplified conceptual illustration of a solicitation conversion rate optimization system, constructed and operative in accordance with a preferred embodiment of the present invention, and additionally to FIG. 2, which is a simplified flowchart illustration of an exemplary method of operation of the system of FIG. 1, operative in accordance with a preferred embodiment of the present invention. In the system and method of FIGS. 1 and 2, two or more forms of a solicitation 100, such as a web page, are prepared by selecting a presentation factor 102 in solicitation 100, being any aspect of solicitation 100 such as a section of text on the web page, and varying the factor, such as by providing alternate versions of the same section of text. The resulting solicitation versions 104A and 104B are then provided to a test group 106 of persons for a period of time in accordance with conventional A/B Testing techniques, such as using a web server 108 to transmit solicitation versions 104A and 104B via a network 110, such as the Internet. The conversion rate of each of the versions is then determined.

With A/B Testing complete, the solicitation version having the highest test group conversion rate, now referred to as the primary solicitation, is selected for presentation from that point onward. However, the presentation rate of the primary solicitation is not set at 100% as would normally-be done at the conclusion of A/B Testing. Rather, in accordance with the present invention, the ongoing presentation rate of the primary solicitation is set at less than 100% of served solicitations, such as 98%. The solicitation version with the lowest test group conversion rate, now referred to as the secondary solicitation, is then selected for ongoing presentation at a rate that is lower than the presentation rate of the primary solicitation, but that is high enough such that it's ongoing conversion rate would be statistically significant, such as at 2% of served solicitations. The actual conversion rates of the primary and secondary solicitations are monitored on an ongoing basis, such as by server 108. The presentation rates of either of the primary and secondary solicitations may be varied upward or downward at any time responsive to a change in the conversion rate of any of the versions. Presentation rate adjustments may be made in predetermined increments or as a predefined function of the change in the conversion rates of the primary and/or secondary solicitations.

A step-by-step exemplary implementation of the present invention is now provided.
1. Select the presentation factors of a solicitation whose conversion rate is to be tested (e.g., link color, wording, background), where each factor has an associated set of candidate values. For the purpose of the present example, it will be assumed that each factor has two candidate values. The two possible values for a given factor are referred to as the first and the second values.
2. Initialization phase:
   During an initialization phase, for each of the presentation factors chosen for a solicitation, choose an initial value, which should preferably be set to the better of the two alternatives, as may be determined by an experienced person. For each of the factors, associate the following variables:
      currentProb: A real number having a value between 0 and 1.0, which is the probability that the first value will be chosen for the next visitor. This value is initialized to a probability that reflects the initial confidence of the human expert (0.5 if no initial preference).
      currentDelta: The minimum value for the currentProb and for (1−currentProb). currentDelta is dependent on parameters such as the mean visitors' arrival rate. currentDelta may itself be time dependent.
3. Execute the following initialization loop for each of the factors:
   Test the set of conversion rates associated with the possible values of the factor during a bounded period of time. This is typically the span of time needed to determine the conversion rates with sufficient statistical confidence.
   During a given test period:
      For any previously tested factors, the preferred value was already computed. It will be used in this phase with a probability=1.0
      All non-tested factors are set=0.5, if no preference exists
      currentProb for the currently tested factor is modified in order to reflect the confidence with which the first value should be chosen.

One possible way of modifying currentProb is by estimating, as a function of the ongoing solicitation presentation rate (e.g., the total visitor rate to the web page whose conversion rate improvement is sought) and the minimum testing window time during which one could detect a statistically significant preference for one of the factor's values.
Sample the conversion rates for both values of the factor during the testing window time. Decide whether to a) maintain the current presentation rates where no statistically significant better conversion rate was found, or b) assign a higher presentation rate (1−currentDelta) to the value having a statistically significant better conversion rate, and the complementary presentation rate (currentDelta) to the other value.
4. Going forward, two concurrent tasks are performed:
A. The “foreground task” which:
   1. Determines for each new solicitation recipient what values should be chosen for the presentation factors as a function of the current currentProb values.
   2. After each presentation, sends information to the background task relating to the latest recipient, which includes:
      a. The recipient's profile (if known). This will allow segmentation of the recipient population
      b. The presentation choices that were used for the recipient
      c. Whether the presentation led to a conversion success or a failure
B. The “background task” which:
   1. Updates a results repository with the information sent by the foreground task. This may be performed in a similar way to the updating described in step three above, where the results of a factor's values during the last window of time are analyzed in order to detect a possible inversion of the favored value.
   2. Measures and analyzes for each factor the conversion rates associated with its two values;
   3. Adjusts the currentProb values in the range of [currentDelta, 1−currentDelta] in order to optimize the conversion rate.
      Note that the background task may freeze the choices of part of the factors to their current best value in order to more rapidly analyze the conversion rates for the two values of a given factor.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for dynamically optimizing the conversion rate of a solicitation over time, the method comprising:
selecting a presentation factor in a solicitation;
creating at least two versions of said solicitation by varying said factor;
determining a conversion rate for each of said versions;
presenting one of said versions having the highest conversion rate at a first presentation rate;
presenting the other of said versions having the lowest conversion rate at a second presentation rate that is lower than said first presentation rate; and
varying any of said presentation rates responsive to a change in the conversion rate of any of said versions.

2. A method according to claim 1 wherein said varying step comprises varying any of said presentation rates by a predetermined increment.

3. A method according to claim 1 wherein said varying step comprises varying any of said presentation rates in accordance with a predefined function of the change in any of said conversion rates.

4. A method according to claim 1 wherein said determining step comprises determining using A/B testing on a test group.

5. A method according to claim 1 and further comprising:
associating with each of said factors, wherein each factor has an associated set of candidate values, a probability currentprob between 0 and 1 that a given one of said values will be chosen for a next presentation;
associating with each of said factors a minimum value currentDelta for said currentProb and for (1−currentProb);
for each of said factors:
testing said conversion rates associated with said candidate values of said factor during a bounded period of time; and
during said test period:
setting currentProb=1 for any previously tested factor;
setting currentProb=0.5 for all non-tested factors;
modifying currentProb for the currently tested factor in accordance with a predefined function to reflect the confidence with which any of said candidate values should be chosen.
sampling the conversion rates for at least two of said values of a tested factor during said test period;
maintaining the current presentation rates where no statistically significant better conversion rate was found; and
assigning a higher presentation rate (1−currentDelta) to the value having a statistically significant better conversion rate, and a complementary presentation rate (currentDelta) to the other value.

6. A method according to claim 5 and further comprising:
determining for each new solicitation recipient what values should be chosen for said presentation factors as a function of their current currentProb values; and
after each presentation, recording information relating to the latest recipient, including any of recipient profile information, the presentation choices that were used for said recipient, and whether the presentation led to a conversion success or a failure.

7. A method according to claim 6 and further comprising:
updating a results repository with said information;
measuring and analyzing said information to determine if any of said values for any of said factors should be adjusted; and;
adjusting any of said currentProb values in the range of [currentDelta, 1−currentDelta] in order to optimize any of said conversion rates.

8. A system for dynamically optimizing the conversion rate of a solicitation over time, the system comprising:
means for selecting a presentation factor in a solicitation;
means for creating at least two versions of said solicitation by varying said factor;
means for determining a conversion rate for each of said versions;
means for presenting one of said versions having the highest conversion rate at a first presentation rate;
means for presenting the other of said versions having the lowest conversion rate at a second presentation rate that is lower than said first presentation rate; and
means for varying any of said presentation rates responsive to a change in the conversion rate of any of said versions.

9. A system according to claim 8 wherein said means for varying is operative to vary any of said presentation rates by a predetermined increment.

10. A system according to claim 8 wherein said means for varying is operative to vary any of said presentation rates in accordance with a predefined function of the change in any of said conversion rates.

11. A system according to claim 8 wherein said means for determining is operative to determine using A/B testing on a test group.

12. A system according to claim 8 and further comprising:
means for associating with each of said factors, wherein each factor has an associated set of candidate values, a probability currentProb between 0 and 1 that a given one of said values will be chosen for a next presentation;
means for associating with each of said factors a minimum value currentDelta for said currentProb and for (1−currentProb); and
means operative for each of said factors to:
test said conversion rates associated with said candidate values of said factor during a bounded period of time; and during said test period:
set currentProb=1 for any previously tested factor;
set currentProb=0.5 for all non-tested factors;
modify currentProb for the currently tested factor in accordance with a predefined function to reflect the confidence with which any of said candidate values should be chosen.
sample the conversion rates for at least two of said values of a tested factor during said test period;
maintain the current presentation rates where no statistically significant better conversion rate was found; and
assign a higher presentation rate (1−currentDelta) to the value having a statistically significant better conversion rate, and a complementary presentation rate (currentDelta) to the other value.

13. A system according to claim 12 and further comprising:
means for determining for each new solicitation recipient what values should be chosen for said presentation factors as a function of their current currentProb values; and
means for recording after each presentation information relating to the latest recipient, including any of recipient profile information, the presentation choices that were used for said recipient, and whether the presentation led to a conversion success or a failure.

14. A system according to claim 13 and further comprising:
means for updating a results repository with said information;
means for measuring and analyzing said information to determine if any of said values for any of said factors should be adjusted; and;
means for adjusting any of said currentProb values in the range of [currentDelta, 1−currentDelta] in order to optimize any of said conversion rates.

15. A computer-implemented program embodied on a computer-readable medium, the computer program comprising:
a first code segment operative to select a presentation factor in a solicitation;
a second code segment operative to create at least two versions of said solicitation by varying said factor;
a third code segment operative to determine a conversion rate for each of said versions;
a fourth code segment operative to present one of said versions having the highest conversion rate at a first presentation rate;
a fifth code segment operative to present the other of said versions having the lowest conversion rate at a second presentation rate that is lower than said first presentation rate; and
a sixth code segment operative to vary any of said presentation rates responsive to a change in the conversion rate of any of said versions.
